(19) United States
(12) Patent Application Publication
(10) Pub. No.: US 2025/0020470 A1
(43) Pub. Date: Jan. 16, 2025

(54) METHOD OF DUST POLLUTION MONITORING AND RISK FOREWARNING FOR DRY BULK PORT BASED ON INSPECTION ROBOT

(71) Applicant: DALIAN UNIVERSITY OF TECHNOLOGY, Dalian (CN)

(72) Inventors: Wenyuan WANG, Dalian (CN); Xinglu XU, Dalian (CN); Yun PENG, Dalian (CN); Zijian GUO, Dalian (CN)

(21) Appl. No.: 18/901,918

(22) Filed: Sep. 30, 2024

(30) Foreign Application Priority Data
Oct. 16, 2023 (CN) 202311331519.3

(51) Int. Cl. G01C 21/20; G01D 21/02

(52) U.S. Cl. CPC G01C 21/20; G01D 21/02

(57) ABSTRACT

A method of dust pollution monitoring and risk forewarning for a dry bulk port based on an inspection robot belongs to the technical field of environmental monitoring. The method plans an inspection route of the inspection robot in the stage of the inspection robot path planning, and makes the inspection robot perform an inspection task automatically along the planned route; in the stage of data acquisition, transmission, and processing, a multi-source environmental monitoring module installed on the inspection robot is used for monitoring the concentration of dust pollutants in the air and environmental parameters in real-time; and in the stage of data analysis and risk forewarning, the monitoring data is analyzed and visualized to judge a possible over-standard risk of dust pollutant concentration and perform forewarning. The present invention can improve the resolution and flexibility of dust pollution monitoring in the dry bulk port.

### TECHNICAL FIELD

The present invention belongs to the technical field of environmental monitoring, and particularly relates to a method of dust pollution monitoring and forewarning for a dry bulk port based on an inspection robot.

### BACKGROUND

Dust pollution is the main pollutant produced during operation of the dry bulk port. Dust pollution monitoring plays an important role in dust pollution control. On the one hand, dust pollution monitoring can help port staff to grasp the time change and the spatial distribution of dust pollutant concentrations in the port region. On the other hand, dust pollution monitoring can discover the existing or impending over-standard pollution risk in the port region in time, so as to give timely forewarning. Dust pollution monitoring can provide a large number of real and effective monitoring data, provide data support for management and law enforcement of environmental departments, and provide decision reference for port managers to grasp the time change trend and the spatial distribution characteristics of dust pollution concentrations in the port region and take effective control measures in time.

At present, fixed environmental monitoring stations are mainly used in the dry bulk port for long-time continuous monitoring of dust pollution. However, due to the complex terrain and meteorological conditions in the dry bulk port region and the variable characteristics of pollution sources inside the port, the distribution of the concentrations of dust pollutants is not even in space. The sensor is only sensitive to the dust pollutants in a small region. Thus, the monitoring resolution of the fixed environmental monitoring stations depends on the number and the density of the installed stations. However, due to the limited space in the dry bulk port region and high cost of purchase, arrangement and maintenance of the monitoring stations, it is impossible to improve the monitoring resolution through dense arrangement of the monitoring stations. Therefore, in practical engineering, a monitoring network composed of a small number of fixed environmental monitoring stations is often used for multi-point synchronous monitoring, and mobile ends such as unmanned aerial vehicles and underway vehicles are simultaneously used for supplementary monitoring. However, there are problems of measurement inaccuracy caused by airflow interference in the unmanned aerial vehicles, and limited sampling height and short endurance caused by the influence of complex terrain in the port region. In addition, the underway vehicles have a problem of incapability of going deep into the yard, a dock front and other regions, so it is difficult to identify the local over-standard risk of dust pollution in the port region and provide timely forewarning.

### SUMMARY

To solve the above problems, the present invention proposes a method of dust pollution monitoring and risk forewarning for a dry bulk port based on an inspection robot, so as to movably monitor the concentration of surface dust pollutants in the interior of a yard and a dock front on the basis of fixed environmental monitoring stations, supplement the monitoring data of the fixed environmental monitoring stations, detect the over-standard risk of dust pollution in the dry bulk port in real-time through intelligent analysis and visualization of mobile monitoring data and perform timely forewarning.

To achieve the above purpose, the present invention adopts the following technical solution:
A method of dust pollution monitoring and risk forewarning for a dry bulk port based on an inspection robot comprises three steps of inspection robot path planning, data acquisition, transmission and processing, and data analysis and risk forewarning. Wherein in the stage of the inspection robot path planning, the inspection route of the inspection robot is planned and inputted into the inspection robot according to factors such as terrain and wind direction of the port, so that the inspection robot performs an inspection task automatically along the planned route; in the stage of data acquisition, transmission and processing, a multi-source environmental monitoring module installed on the inspection robot is used for monitoring the concentration of dust pollutants in the air and environmental parameters such as wind speed, wind direction and temperature in real-time during inspection, and a data transmission module is used for transmitting the monitoring data to a port data center for processing; in the stage of data analysis and risk forewarning, the monitoring data processed by the data processing module is analyzed and visualized to judge a possible over-standard risk of dust pollutant concentration and perform forewarning. Specific steps are as follows:
step 1: inspection robot path planning: obtaining map data of the dry bulk port, and establishing a grid map according to the map data by a grid method; determining an inspection region, an inspection starting point, an inspection endpoint and an inspection point of the inspection robot based on the grid map according to the layout and the wind direction of the fixed environmental monitoring stations; based on the above initial conditions, planning the inspection path of the inspection robot, inputting the inspection path into the inspection robot, and making the inspection robot automatically perform the inspection task according to the planned inspection path through a GPS positioning module and a motion control module;
step 2: data acquisition, transmission and processing: in a process that the inspection robot moves along the planned path, monitoring dust pollutant concentration in the air, wind speed, wind direction, temperature, relative humidity, atmospheric pressure and other environmental parameters through the multi-source environmental monitoring module installed on the inspection robot, and recording a sampling position in real-time through the GPS positioning module; transmitting real-time monitoring data, timestamp data and GPS positioning data to the port data center by a wireless transmission mode through the data transmission module, and fusing the monitoring data, the timestamp data and the GPS positioning data;
step 3: data analysis and risk forewarning: performing interpolation completion of the monitoring data between adjacent timestamps based on the processed monitoring data through a linear interpolation method; visualizing the data after interpolation to display the distribution of dust pollutant concentrations on the inspection path of the inspection robot; setting different dust pollutant concentration thresholds for different regions of the dry bulk port; when the dust pollutant concentration monitored in real-time exceeds the threshold of the region at the position, sending an forewarning signal to the port data center, and reporting the dust pollutant concentration and position information in the over-standard position.

As a further preferred solution of the method of dust pollution monitoring and risk forewarning for the dry bulk port based on the inspection robot, the step 1 is specifically as follows:
step 1.1: importing the map data of the dry bulk port, preprocessing the map data, and dividing the preprocessed map data into grids by a grid method; expanding the grids where obstacles in the grid map are located according to the information of obstacles such as stacks, stacker-reclaimer tracks, ship loader tracks, belt conveyors, vehicle roads, green belts and buildings in the map, and labeling the positions of the fixed environmental monitoring stations in the grid map;
step 1.2: selecting an uncovered region such as a downwind region of the fixed environmental monitoring stations as an inspection region of the inspection robot according to a relative relationship between the position and the wind direction of the fixed environmental monitoring stations, determining a starting point, an endpoint and middle inspection points of the inspection path according to monitoring needs, and labeling in the grid map;
step 1.3: planning the inspection path of the inspection robot from the starting point to the endpoint through the middle inspection points according to the starting point, the endpoint and the middle inspection points of the determined inspection path; inputting the planned inspection path into the inspection robot, and performing, by the inspection robot, inspection according to the planned inspection path through the GPS positioning module and the motion control module.

As a further preferred solution of the method of dust pollution monitoring and risk forewarning for the dry bulk port based on the inspection robot, the step 2 is specifically as follows:
step 2.1: the multi-source environmental monitoring module installed on the inspection robot comprises a light scattering particle concentration sensor, a temperature sensor, an anemometer, a wind indicator, a relative humidity sensor and an atmospheric pressure sensor; fusing all the sensors in the same module, and sampling and measuring the dust pollutant concentration, wind speed, wind direction, temperature and other environmental parameters with the same timestamp and sampling frequency;
step 2.2: measuring the sampling position of the inspection robot with the same timestamp as that of the multi-source environmental monitoring module through the GPS positioning module installed on the inspection robot;
step 2.3: transmitting the environmental monitoring data obtained by the multi-source environmental monitoring module and the sampling position data obtained by the GPS positioning module to the port data center in real-time using 5G technology through the data transmission module installed on the inspection robot;
step 2.4: fusing the environmental monitoring data and the sampling position data transmitted by the inspection robot with the timestamp through the port data center, and processing lost, wrong and outlier data.

As a further preferred solution of the method of dust pollution monitoring and risk forewarning for the dry bulk port based on the inspection robot, the step 3 is specifically as follows:
step 3.1: performing linear interpolation completion for the data after data fusion and processing to obtain the fusion data of the environmental monitoring data, the sampling position data and the timestamp data with equal time intervals;
step 3.2: labeling the dust pollutant concentration data at each sampling position in the dry bulk port map in the order of the timestamps by using a data visualization technology according to the environmental monitoring data and the sampling position data of each timestamp, and drawing a thermodynamic diagram of dust pollutant concentrations accordingly, wherein the darker the color is, the higher the dust pollutant concentration is; and the lighter the color is, the lower the dust pollutant concentration is;
step 3.3: setting dust pollutant concentration thresholds for different regions according to the requirements of total dust concentration limits for different inspection operating sections in the “Port Coal Dust Concentration Control Index and Test Method JT/T 1376-2021”; when the dust pollutant concentration monitored by the inspection robot in real-time exceeds the concentration threshold of the region at the position, sending an forewarning signal to the port data center by the inspection robot to prompt port staff that an over-standard event of the dust pollutant concentration occurs at the position.

Compared with the prior art, the present invention has the following effects and benefits:

The present invention grids the dry bulk port map by the grid method, and expands the obstacles in the grid map according to the actual obstacle information in the map to obtain the grid map of the dry bulk port; plans the inspection path of the inspection robot according to the terrain and wind direction information of the dry bulk port, and adopts the motion control module to control the inspection robot to move along the planned path; uses the multi-source environmental monitoring module to measure the concentration of dust pollutants in the air and environmental parameters such as wind speed, wind direction and temperature; records the sampling position of the inspection robot by using the GPS positioning module; wirelessly transmits the monitoring data and the position data to the port data centers by using 5G technology; fuses the monitoring data, the position data and the timestamp data, and supplements the data by the linear interpolation method; displays the concentration level of dust pollutants on the inspection path on the map by the visualization technology, and warns the over-standard event of the dust pollutant concentration according to the dust pollutant concentration thresholds in different region. Compared with the prior art, the present invention can reduce the number and the cost of the fixed environmental monitoring stations, can perform supplementary monitoring of the regions not covered by the fixed environmental monitoring stations, and the regions not entered by underway vehicles and unmanned aerial vehicles such as dry bulk yards and dock fronts to improve the resolution and flexibility of dust pollution monitoring in the dry bulk port, and can warn local over-standard events of the dust pollutant concentrations in the dry bulk port in real-time.

### DESCRIPTION OF DRAWINGS

FIG. 1 is a flow chart of a method of dust pollution monitoring and risk forewarning for a dry bulk port based on an inspection robot;

FIG. 2 is a grid map of the dry bulk port after grid processing;

FIG. 3 is a path planning diagram of an inspection robot;

FIG. 4 shows positions and time of over-standard pollution events found in an inspection process.

### DETAILED DESCRIPTION

The technical solutions in embodiments of the present invention will be clearly and fully described below in combination with embodiments in the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

A method of dust pollution monitoring and risk forewarning for a dry bulk port based on an inspection robot comprises three steps of inspection robot path planning, data acquisition, transmission and processing, and data analysis and risk forewarning. Wherein in the stage of the inspection robot path planning, the inspection route of the inspection robot is planned and inputted into the inspection robot according to factors such as terrain and wind direction of the port, so that the inspection robot performs an inspection task automatically along the planned route; in the stage of data acquisition, transmission and processing, a multi-source environmental monitoring module installed on the inspection robot is used for monitoring the concentration of dust pollutants in the air and environmental parameters such as wind speed, wind direction and temperature in real-time during inspection, and a data transmission module is used for transmitting the monitoring data to a port data center for processing; in the stage of data analysis and risk forewarning, the monitoring data processed by the data processing module is analyzed and visualized to judge a possible over-standard risk of dust pollutant concentration and perform forewarning.

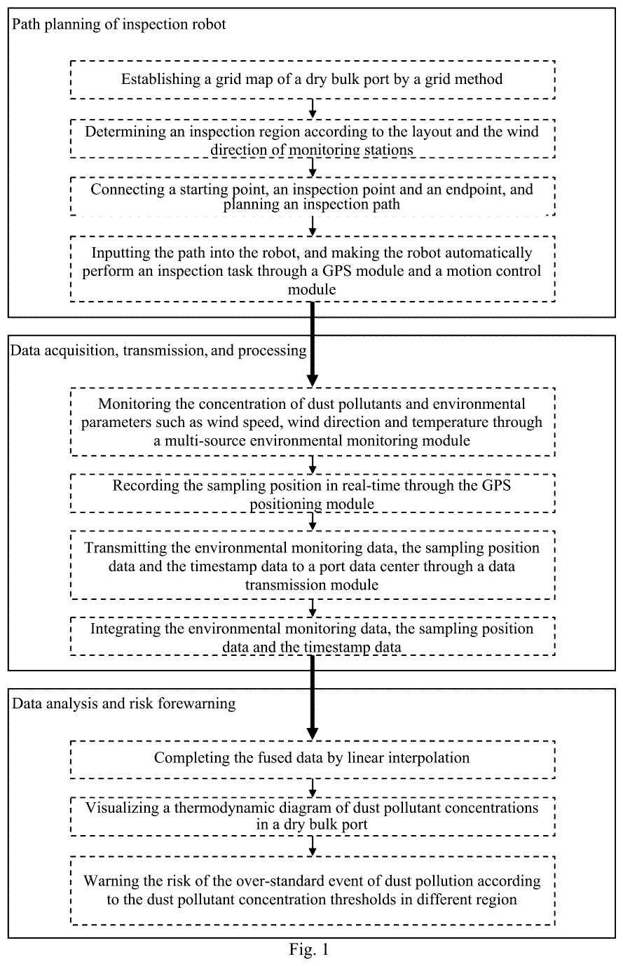

As shown in FIG. 1, the method specifically comprises the following steps:
(1) inspection robot path planning: obtaining map data of the dry bulk port, and establishing a grid map according to the map data by a grid method; determining an inspection region, an inspection starting point, an inspection endpoint and an inspection point of the inspection robot based on the grid map according to the layout and the wind direction of the fixed environmental monitoring stations; based on the above initial conditions, planning the inspection path of the inspection robot, inputting the inspection path into the inspection robot, and making the inspection robot automatically perform the inspection task according to the planned inspection path through a GPS positioning module and a motion control module;
(2) data acquisition, transmission and processing: in a process that the inspection robot moves along the planned path, monitoring dust pollutant concentration in the air, wind speed, wind direction, temperature, relative humidity, atmospheric pressure and other environmental parameters through the multi-source environmental monitoring module installed on the inspection robot, and recording a sampling position in real-time through the GPS positioning module; transmitting real-time monitoring data, timestamp data and GPS positioning data to the port data center by a wireless transmission mode through the data transmission module, and fusing the monitoring data, the timestamp data and the GPS positioning data;
(3) data analysis and risk forewarning: performing interpolation completion of the monitoring data between adjacent timestamps based on the processed monitoring data through a linear interpolation method; visualizing the data after interpolation to display the distribution of dust pollutant concentrations on the inspection path of the inspection robot; setting different dust pollutant concentration thresholds for different regions of the dry bulk port; when the dust pollutant concentration monitored in real-time exceeds the threshold of the region at the position, sending an forewarning signal to the port data center, and reporting the dust pollutant concentration and position information in the over-standard position.

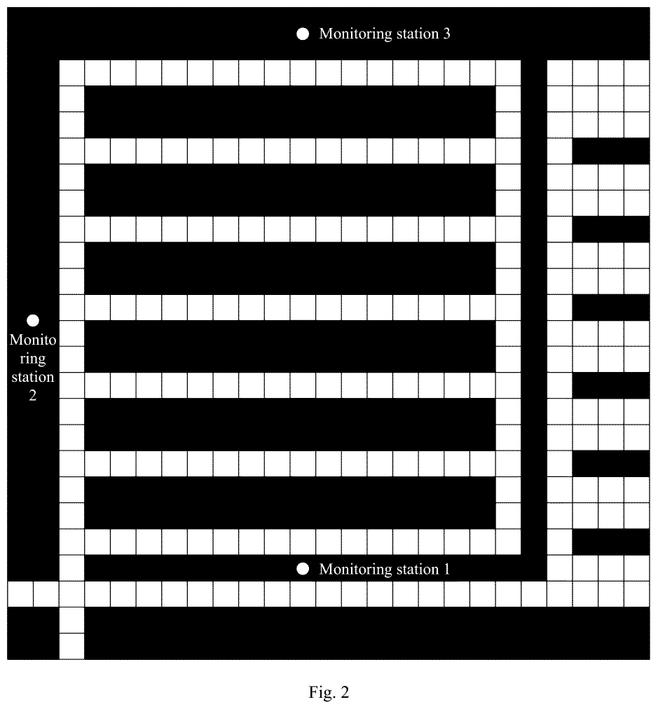

The path planning step of the inspection robot is as follows:
a: in the present embodiment, importing the map data of the dry bulk port, preprocessing the map data, and dividing the preprocessed map data into grids by a grid method; expanding the grids where obstacles in the grid map are located according to the information of obstacles such as stacks, stacker-reclaimer tracks, ship loader tracks, belt conveyors, vehicle roads, green belts and buildings in the map, and labeling the positions of the fixed environmental monitoring stations in the grid map to obtain the grid map of the dry bulk port, as shown in FIG. 2;
b: in the present embodiment, selecting an uncovered region such as a downwind region of the fixed environmental monitoring stations as an inspection region of the inspection robot by considering a relative relationship between the position and the wind direction of the fixed environmental monitoring stations based on the grid map of the dry bulk port; taking the port data center as a starting point and an endpoint of the inspection path, and taking the loading and unloading points of each stack and a dock front in the dry bulk port as middle inspection points;

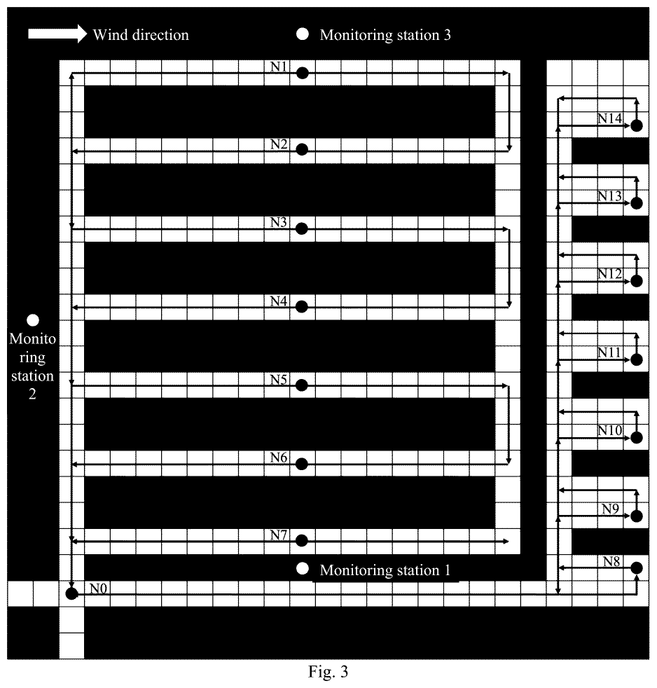

c: in the present embodiment, planning the inspection path of the inspection robot from the starting point to the endpoint through the middle inspection points based on the inspection starting point, the endpoint and the middle inspection points determined in the grid map of the dry bulk port, as shown in FIG. 3; inputting the planned inspection path into the inspection robot, and performing, by the inspection robot, inspection according to the planned inspection path through the GPS positioning module and the motion control module.

The step of data acquisition, transmission and processing is as follows:
a: in the present embodiment, fusing, by the multi-source environmental monitoring module installed on the inspection robot, a light scattering particle concentration sensor, a temperature sensor, an anemometer, a wind indicator, a relative humidity sensor and an atmospheric pressure sensor; and sampling and measuring the dust pollutant concentration in the air, wind speed, wind direction, temperature and other environmental parameters with the same timestamp and sampling frequency;
b: in the present embodiment, measuring the sampling position of the inspection robot with the same timestamp while sampling by the multi-source environmental monitoring module through the GPS positioning module installed on the inspection robot;
c: in the present embodiment, transmitting the environmental monitoring data, the timestamp data and the sampling position data to the port data center using 5G technology through the data transmission module installed on the inspection robot;
d. integrating, by the port data center, the environmental monitoring data, the timestamp data and the sampling position data transmitted by the inspection robot, and deleting lost, wrong and outlier values. The fused data structure is shown in Table 1:

TABLE 1
Fused Data Structure

| | | | | | | |
|---|---|---|---|---|---|---|
| Sampling | Sampling | Dust | Temper- | Wind | . . . | Atmo- |
| Time | Position | Pollutant | ature | Speed | | spheric |
| | | Concen- | | | | Pressure |
| | | tration | | | | |

The step of data analysis and risk forewarning is as follows:
a: completing the data after data fusion and processing by a linear interpolation method to make the time intervals of adjacent data equal;
b: visualizing the completed fusion data, labeling dust pollutant concentration data at each sampling position in the dry bulk port map in the order of the timestamps, and drawing a thermodynamic diagram of dust pollutant concentrations, wherein the darker the color is, the higher the dust pollutant concentration is; and the lighter the color is, the lower the dust pollutant concentration is;

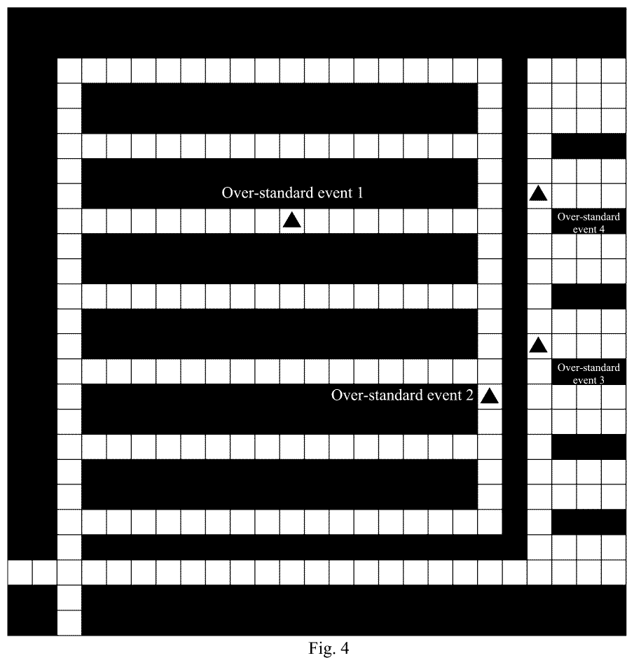

c: setting dust pollutant concentration thresholds for different regions according to the requirements of total dust concentration limits for different inspection sections in the “Port Coal Dust Concentration Control Index and Test Method JT/T 1376-2021”. In the present embodiment, the threshold is 20 mg/m³ at the yard and operating road, the threshold is 30 mg/m³ at the stacker, reclaimer and stacker-reclaimer, and the threshold is 50 mg/m³ at the ship loader and the ship unloader. When the inspection robot monitors that the dust pollutant concentration exceeds the threshold of the region at a place in the above each region, the inspection robot sends an forewarning signal to the port data center to prompt port staff that an over-standard event of the dust pollutant concentration occurs at the position. In the present embodiment, the position where the over-standard event of dust pollution occurs is shown in FIG. 4. The over-standard event 1 occurs 690 seconds after the inspection robot starts from the starting point, and the real-time dust pollutant concentration reaches 37 mg/m³. The over-standard event 2 occurs 1180 seconds after the inspection robot starts from the starting point, and the real-time dust pollutant concentration reaches 28 mg/m³. The over-standard event 3 occurs 2220 seconds after the inspection robot starts from the starting point, and the real-time dust pollutant concentration reaches 61 mg/m³. The over-standard event 4 occurs 2240 seconds after the inspection robot starts from the starting point, and the real-time dust pollutant concentration reaches 56 mg/m³.

Based on the embodiments in the present invention, any modification, equivalent replacement and improvement made to all other embodiments obtained by those ordinary skilled in the art without contributing creative labor will be included in the protection scope of the present invention.

1. A method of dust pollution monitoring and risk forewarning for a dry bulk port based on an inspection robot, comprising three steps of inspection robot path planning, data acquisition, transmission and processing, and data analysis and risk forewarning; wherein in the stage of the inspection robot path planning, the inspection route of the inspection robot is planned and inputted into the inspection robot according to factors of the port, so that the inspection robot performs an inspection task automatically along the planned route; in the stage of data acquisition, transmission and processing, a multi-source environmental monitoring module installed on the inspection robot is used for monitoring the concentration of dust pollutants in the air and environmental parameters in real-time during inspection, and a data transmission module is used for transmitting the monitoring data to a port data center for processing; in the stage of data analysis and risk forewarning, the monitoring data processed by the data processing module is analyzed and visualized to judge a possible over-standard risk of dust pollutant concentration and perform forewarning.

2. The method of dust pollution monitoring and risk forewarning for the dry bulk port based on the inspection robot according to claim 1, wherein specific steps are as follows:
step 1: inspection robot path planning: obtaining map data of the dry bulk port, and establishing a grid map according to the map data by a grid method; determining an inspection region, an inspection starting point, an inspection endpoint, and an inspection point of the inspection robot based on the grid map according to the layout and the wind direction of the fixed environmental monitoring stations; based on the above initial conditions, planning the inspection path of the inspection robot, inputting the inspection path into the inspection robot, and making the inspection robot automatically perform the inspection task according to the planned inspection path through a GPS positioning module and a motion control module;
step 2: data acquisition, transmission, and processing: in a process that the inspection robot moves along the planned path, monitoring dust pollutant concentration in the air, wind speed, wind direction, temperature, relative humidity, atmospheric pressure, and other environmental parameters through the multi-source environmental monitoring module installed on the inspection robot, and recording a sampling position in real-time through the GPS positioning module; transmitting real-time monitoring data, timestamp data and GPS positioning data to the port data center by a wireless transmission mode through the data transmission module, and fusing the monitoring data, the timestamp data and the GPS positioning data;
step 3: data analysis and risk forewarning: performing interpolation completion of the monitoring data between adjacent timestamps based on the processed monitoring data through a linear interpolation method; visualizing the data after interpolation to display the distribution of dust pollutant concentrations on the inspection path of the inspection robot;
setting different dust pollutant concentration thresholds for different regions of the dry bulk port, when the dust pollutant concentration monitored in real-time exceeds the threshold of the region at the position, sending a forewarning signal to the port data center, and reporting the dust pollutant concentration and position information in the over-standard position.

3. The method of dust pollution monitoring and risk forewarning for the dry bulk port based on the inspection robot according to claim 2, wherein step 1 is specifically as follows:
step 1.1: importing the map data of the dry bulk port, preprocessing the map data, and dividing the preprocessed map data into grids by a grid method; expanding the grids where obstacles in the grid map are located according to the information of stacks, stacker-reclaimer tracks, ship loader tracks, belt conveyors, vehicle roads, green belts, buildings and other obstacles in the map, and labeling the positions of the fixed environmental monitoring stations in the grid map;
step 1.2: selecting an uncovered region such as a downwind region of the fixed environmental monitoring stations as an inspection region of the inspection robot according to a relative relationship between the position and the wind direction of the fixed environmental monitoring stations, determining a starting point, an endpoint and middle inspection points of the inspection path according to monitoring needs, and labeling in the grid map;
step 1.3: planning the inspection path of the inspection robot from the starting point to the endpoint through the middle inspection points according to the starting point, the endpoint, and the middle inspection points of the determined inspection path; inputting the planned inspection path into the inspection robot, and performing, by the inspection robot, inspection according to the planned inspection path through the GPS positioning module and the motion control module.

4. The method of dust pollution monitoring and risk forewarning for the dry bulk port based on the inspection robot according to claim 2, wherein step 2 is specifically as follows:
step 2.1: the multi-source environmental monitoring module installed on the inspection robot comprises a light scattering particle concentration sensor, a temperature sensor, an anemometer, a wind indicator, a relative humidity sensor, and an atmospheric pressure sensor; fusing all the sensors in the same module, and sampling and measuring the dust pollutant concentration, wind speed, wind direction, temperature and other environmental parameters with the same timestamp and sampling frequency;
step 2.2: measuring the sampling position of the inspection robot with the same time stamp as that of the multi-source environmental monitoring module through the GPS positioning module installed on the inspection robot;
step 2.3: transmitting the environmental monitoring data obtained by the multi-source environmental monitoring module and the sampling position data obtained by the GPS positioning module to the port data center in real-time using 5G technology through the data transmission module installed on the inspection robot;
step 2.4: fusing the environmental monitoring data and the sampling position data transmitted by the inspection robot with the timestamp through the port data center, and processing lost, wrong and outlier data.

5. The method of dust pollution monitoring and risk forewarning for the dry bulk port based on the inspection robot according to claim 2, wherein step 3 is specifically as follows:
step 3.1: performing linear interpolation completion for the data after data fusion and processing to obtain the fusion data of the environmental monitoring data, the sampling position data, and the timestamp data with equal time intervals;
step 3.2: labeling the dust pollutant concentration data at each sampling position in the dry bulk port map in the order of the timestamps by using a data visualization technology according to the environmental monitoring data and the sampling position data of each timestamp, and drawing a thermodynamic diagram of dust pollutant concentrations accordingly, wherein the darker the color is, the higher the dust pollutant concentration is; and the lighter the color is, the lower the dust pollutant concentration is;
step 3.3: setting dust pollutant concentration thresholds for different regions according to the requirements of total dust concentration limits for different inspection operating sections; when the dust pollutant concentration monitored by the inspection robot in real-time exceeds the concentration threshold of the region at the position, sending a forewarning signal to the port data center by the inspection robot to prompt port staff that an over-standard event of the dust pollutant concentration occurs at the position.
